(19) United States
(12) Patent Application Publication
(10) Pub. No.: US 2013/0100253 A1
(43) Pub. Date: Apr. 25, 2013

(54) IMAGE PROCESSING DEVICE, IMAGING CAPTURING DEVICE, AND METHOD FOR PROCESSING IMAGE

(71) Applicant: FUJIFILM Corporation, Tokyo (JP)

(72) Inventor: Youichi SAWACHI, Saitama-shi (JP)

(73) Assignee: FUJIFILM CORPORATION, Tokyo (JP)

(21) Appl. No.: 13/711,251

(22) Filed: Dec. 11, 2012

Related U.S. Application Data
(63) Continuation of application No. PCT/JP2011/064727, filed on Jun. 28, 2011.

(30) Foreign Application Priority Data
Jun. 30, 2010 (JP) 2010-150384

(51) Int. Cl. H04N 13/02

(52) U.S. Cl. CPC H04N 13/0239
USPC 348/47

(57) ABSTRACT

To remove visual discomfort during a zooming period, thereby enabling an observer not to feel fatigued.

An image processing device includes an imaging unit that acquires stereoscopic images formed by a plurality of viewpoint images, an operation unit that acquires a zoom value, a parallax amount calculation unit that calculates a parallax amount of each pixel between the plurality of viewpoint images, and a parallax amount correction unit that corrects the parallax amount of each pixel of the stereoscopic images according to the parallax amount of each pixel calculated by the parallax amount calculation unit and the zoom value.

### BACKGROUND OF THE INVENTION

1. Field of the Invention

The present invention relates to an image processing device, an image capturing device, and an image processing method capable of performing variable magnification of stereoscopic images formed by a plurality of viewpoint images.

2. Description of the Related Art

In the related art, variable magnification (zooming) of stereoscopic images formed by a plurality of viewpoint images has been performed.

JP2003-52058A discloses that centers of a left eye image and a right eye image are made to match each other according to the zoom, and a depth direction of a stereoscopic image is varied by controlling a shift amount of the left eye image and a right eye image according to the zoom.

JP-H8-317429A discloses that the maximum parallax amount and the minimum parallax amount are made to lie in a set range by controlling start points and image horizontal positions (shift amount) of respective viewpoint images (a left eye image and a right eye image) according to an electronic zoom of a stereoscopic image, and a depth direction of the stereoscopic image is adjusted (mainly so as to be fixed).

### SUMMARY OF THE INVENTION

In the related art, when a stereoscopic image is captured, for example, a focused main subject is placed at the centers of respective viewpoint images (a left eye image and a right eye image), and photographing is performed by setting the convergence such that a parallax amount of the main subject is the minimum.

However, if zooming is performed from the wide angle side to the telescopic side in this state, a subject movement occurs such that a subject in front of the main subject becomes closer and a distant subject becomes more distant. Therefore, considerable visual discomfort is caused, and thus fatigue increases.

In addition, this leads to images in which stereoscopic fusion is not possible such as where there is parallax excess or parallax divergence, and thereby there is concern about safety.

JP2003-52058A and JP-H8-317429A do not disclose any image process during zooming.

The present invention has been made in consideration of these circumstances, and an object thereof is to provide an image processing device, an image capturing device, and an image processing method enabling an observer not to feel fatigued by removing visual discomfort during a zooming period.

According to an embodiment of the present invention, there is provided an image processing device including an image acquisition unit that acquires stereoscopic images formed by a plurality of viewpoint images; a zoom value acquisition unit that acquires a zoom value; a parallax amount calculation unit that calculates a parallax amount of each pixel between the plurality of viewpoint images; and a parallax amount correction unit that corrects variation amounts of the parallax amounts of at least some pixels of the stereoscopic images acquired by the image acquisition unit relative to a variation amount per unit of the zoom value, according to the parallax amount of each pixel calculated by the parallax amount calculation unit and the zoom value acquired by the zoom value acquisition unit, in relation to the plurality of viewpoint images.

That is to say, since a parallax amount of each pixel between a plurality of viewpoint images is calculated, and the parallax amount of each pixel of stereoscopic images is corrected according to the calculated parallax amount of each pixel and a zoom value, a positional movement of a subject image during zooming can be corrected to a natural movement, and thus this enables an observer not to feel fatigued by removing visual discomfort.

In the embodiment of the present invention, preferably, the parallax amount correction unit corrects the parallax amount, so as for a parallax amount of a subject of the same subject distance to increase or be constant when the zoom value varies from a wide angle side to a telescopic side in the stereoscopic still images after being corrected in a case where the parallax amount of the subject of the same subject distance decreases when the zoom value varies from the wide angle side to the telescopic side in the stereoscopic images before being corrected.

In other words, since a parallax amount of the same subject distance increases or is constant when a zoom value varies from the wide angle side to the telescopic side, an effect of emphasizing the zooming can be achieved.

In the embodiment of the present invention, preferably, the parallax amount correction unit corrects the parallax amount by multiplying the parallax amount before being corrected by a coefficient and shifting the parallax amount after being multiplied.

In addition, in the embodiment of the present invention, preferably, the parallax amount correction unit corrects the parallax amount so as for a shift amount of the parallax amount to increase from a telescopic end to a wide angle end.

In the embodiment of the present invention, preferably, the parallax amount correction unit corrects the parallax amount so as for a parallax amount of a subject of the same subject distance to nonlinearly increase when the zoom value varies from a wide angle end to a telescopic end.

In other words, a movement state of a subject image in stereoscopic images can be observed more acceleratedly in response to a zooming operation, and thus zooming can be further emphasized.

In the embodiment of the present invention, preferably, the parallax amount correction unit corrects the parallax amount so as to lie in a range from a specific upper limit value to a specific lower limit value.

In other words, since parallax excess and parallax divergence can be prevented, and the slope of a variation amount of a parallax amount relative to a variation amount of a zoom value can also be increased, an observer's eyes can be suppressed from feeling fatigued, and zooming can be emphasized.

In the embodiment of the present invention, the image processing device preferably further includes a setting information input unit that receives an input of setting information for setting a parallax amount correction value used to correct the parallax amount; and a parallax amount correction value calculation unit that calculates the parallax amount correction value based on the setting information input by the setting information input unit.

In other words, parallax amount correction suitable for setting information is possible due to an input of the setting information, and thus the most can be made of a zooming effect.

In the embodiment of the present invention, the setting information is preferably a display size of the stereoscopic images.

In the embodiment of the present invention, the image processing device preferably further includes a parallax amount correction value calculation unit that sets the zoom value to a telescopic end or a wide angle end, and calculates a correction value of the parallax amount based on a parallax amount of a focused pixel.

In the embodiment of the present invention, the setting information preferably includes at least one of subject distance information of the closest subject and subject distance information of the most distant subject. In addition, the “subject distance of the closest subject” described here refers to a distance to a subject closest to the image acquisition unit when the image acquisition unit is used as a reference point, and the “subject distance of the most distant subject” refers to a distance to a subject located most distant from the image acquisition unit when the image acquisition unit is used as a reference point.

In the embodiment of the present invention, the image processing device preferably further includes a zoom effect setting information input unit that receives an input of zoom effect setting information for setting a variation amount of the parallax amount relative to a variation amount per unit of the zoom value; and a parallax correction value calculation unit that calculates a parallax amount correction value based on the zoom effect setting information input by the zoom effect setting information input unit.

In addition, according to another embodiment of the present invention, there is provided an image capturing device including the image processing device, wherein the image acquisition unit includes an imaging lens having a zoom lens; and an imaging device capturing a subject image formed by the imaging lens, and wherein the zoom value acquisition unit acquires a zoom value of the zoom lens.

According to still another embodiment of the present invention, there is provided an image processing method, using an image acquisition unit which acquires stereoscopic images formed by a plurality of viewpoint images, a zoom value acquisition unit which acquires a zoom value, and an output unit which outputs the stereoscopic image, the method including calculating a parallax amount of each pixel between the plurality of viewpoint images; and correcting variation amounts of the parallax amounts of at least some pixels of the stereoscopic images acquired by the image acquisition unit relative to a variation amount per unit of the zoom value, according to the parallax amount of each pixel calculated in the calculating of the parallax amount and the zoom value acquired by the zoom value acquisition unit, in relation to the plurality of viewpoint images.

According to the present invention, visual discomfort can be removed during a zooming period, thereby enabling an observer not to feel fatigued.

### BRIEF DESCRIPTION OF THE DRAWINGS

FIG. 1 is a configuration example of the image capturing device related to the present invention.

FIG. 2 is a flowchart illustrating an example of the flow of the image process performed in real time when moving images are captured.

FIG. 3 is a flowchart illustrating an example of the flow of the image process performed after the moving images are captured.

FIG. 4 is a diagram illustrating electronic zoom of a still image.

FIG. 5 is a diagram illustrating fade display of a still image.

FIG. 6 is a diagram illustrating a correspondence relationship between a zoom value before parallax is corrected and a parallax amount.

FIG. 7 is a diagram illustrating a correspondence relationship between a zoom value after parallax is corrected and a parallax amount.

FIGS. 8A to 8D are diagrams respectively illustrating a left eye image and a right eye image before parallax is corrected, after parallax is compressed, after parallax is shifted, and after parallax is corrected.

FIG. 9 is a diagram illustrating an example of the table data regulating a correspondence relationship among a zoom value, a parallax amount before being corrected, and a parallax amount after being corrected.

FIG. 10 is a schematic diagram illustrating a state where stereoscopic images are displayed using images after parallax is corrected.

FIG. 11 is a diagram illustrating a correspondence relationship between a zoom value and a parallax amount of an image when parallax is corrected nonlinearly.

FIG. 12 is a diagram illustrating a correspondence relationship between the display size and pixels of a monitor.

FIG. 13 is a diagram illustrating a correspondence relationship between a zoom value and a parallax amount of a viewpoint image after parallax is corrected in a second embodiment.

FIG. 14 is a main part flowchart illustrating an example of the flow of the image process in the second embodiment.

FIG. 15 is a main part flowchart illustrating another example of the flow of the image process in the second embodiment.

FIGS. 16A to 16C are schematic diagrams illustrating a state of a stereoscopic image of a subject during zooming.

FIG. 17 is a diagram illustrating a correspondence relationship between a zoom value and a parallax amount of a viewpoint image after parallax is corrected in a third embodiment.

FIG. 18 is a flowchart illustrating an example of the flow of the user setting process.

FIG. 19 is a flowchart illustrating another example of the flow of the image process performed in real time when moving images are captured.

FIG. 20 is a flowchart illustrating another example of the flow of the image process performed after the moving images are captured.

FIG. 21 is a block diagram illustrating a hardware configuration of a computer apparatus to which the present invention is applied.

### DESCRIPTION OF THE PREFERRED EMBODIMENTS

Hereinafter, embodiments of the present invention will be described in detail with reference to the accompanying drawings.

### First Embodiment

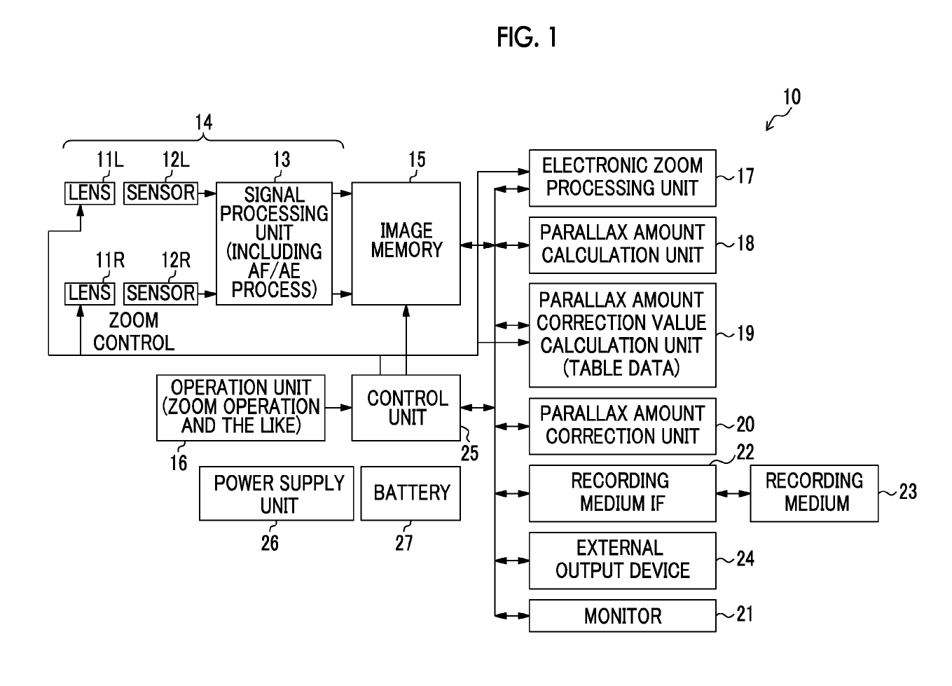

FIG. 1 is a block diagram illustrating a configuration example of the image capturing device related to the present invention.

An image capturing device 10 includes imaging lenses 11L and 11R, imaging sensors 12L and 12R, a signal processing unit 13, an image memory 15, an operation unit 16, an electronic zoom processing unit 17, a parallax amount calculation unit 18, a parallax amount correction value calculation unit 19, a parallax amount correction unit 20, a monitor 21, a recording medium interface 22, a recording medium 23, an external output device 24, a control unit 25, a power supply unit 26, and a battery 27.

The imaging lenses 11L and 11R include an optical system which forms a subject image on light receiving surfaces of the imaging sensors 12L and 12R. The imaging lenses 11L and 11R in this example include a focus lens, a zoom lens, and a diaphragm device.

The imaging sensors 12L and 12R capture the subject image formed on the imaging lenses 11L and 11R respectively. The imaging sensors 12L and 12R include, for example, CCD imaging sensors, CMOS imaging sensors, or the like.

The signal processing unit 13 performs various signal processes such as an AE process, an AF process, and the like, on stereoscopic images (a left eye image and a right eye image) output from the imaging sensors 12L and 12R.

In the image capturing device 10 of this example, the imaging lenses 11L and 11R, the imaging sensors 12L and 12R, and the signal processing unit 13 constitute an imaging unit 14 (image acquisition unit) which acquires stereoscopic images formed by a plurality of viewpoint images.

The image memory 15 is a memory (for example, a RAM) which temporarily stores the stereoscopic images output from the signal processing unit 13 for each frame.

The operation unit 16 is an input device (for example, a key switch) which receives a user's input operation.

In the image capturing device 10 of this example, the operation unit 16 forms a zoom value acquisition unit which acquires a zoom value which varies arbitrarily.

The electronic zoom processing unit 17 variably magnifies the stereoscopic images (a left eye image and a right eye image) through image processing based on a zoom value acquired by the operation unit 16.

The parallax amount calculation unit 18 calculates a parallax amount of each pixel between a plurality of viewpoint images (a left eye image and a right eye image).

The parallax amount correction value calculation unit 19 calculates a parallax amount correction value for correcting a parallax amount of each pixel of the stereoscopic images (a left eye image and a right eye image) according to the parallax amount calculated by the parallax amount calculation unit 18 and the zoom value acquired by the operation unit 16.

The parallax amount correction unit 20 corrects the parallax amount of each pixel of the stereoscopic images (a left eye image and a right eye image) based on the parallax amount correction value calculated by the parallax amount correction value calculation unit 19. That is to say, parallax amount of each pixel of the stereoscopic images is corrected according to the parallax amount calculated by the parallax amount calculation unit 18 and the zoom value acquired by the operation unit 16. Through the correction of a parallax amount, a variation amount of a parallax amount relative to a variation amount per unit of a zoom value is changed. Specifically, in a case where a parallax amount of a subject of the same subject distance decreases when a zoom value varies from the wide angle side to the telescopic side in the stereoscopic images before being corrected, the parallax amount correction unit 20 corrects a parallax amount such that a parallax amount of the subject of the same subject distance increases or is constant when the zoom value varies from the wide angle side to the telescopic side in the stereoscopic images after being corrected. In addition, the parallax amount correction is not particularly limited to a case of being performed on all regions of the stereoscopic images, and at least some regions of the stereoscopic images may be corrected.

The monitor 21, the recording medium interface 22, and the external output device 24 output the stereoscopic images.

The monitor 21 is a display device which can display stereoscopic images in stereoscopic vision.

The recording medium interface 22 is an example of the external output device 24 and records stereoscopic images on the recording medium 23 such as a memory card.

The external output device 24 includes, for example, a communication interface which outputs (transmits) the stereoscopic images by communication.

The control unit 25 controls the respective units of the image capturing device 10. While the zoom value acquired by the operation unit 16 varies, the control unit 25 of this example variably magnifies stereoscopic images of one frame immediately before or after the zoom value varies using the electronic zoom processing unit 17 and outputs the variably magnified still images (stereoscopic still images) of one frame using the external output device 24, and, when the zoom value does not vary, the control unit 25 outputs the stereoscopic images as moving images using the external output device 24.

In addition, the control unit 25 sets a display duration of the variably magnified still images to be longer than a variation duration of the zoom value.

Further, the control unit 25 outputs stereoscopic still images which are variably magnified in a stepwise manner by increasing the zoom value in a stepwise manner, using an output unit such as the monitor 21.

In addition, the control unit 25 changes a plurality of variably magnified still images through fade-in and fade-out.

The power supply unit 26 supplies power from the battery 27 to the respective units of the image capturing device 10.

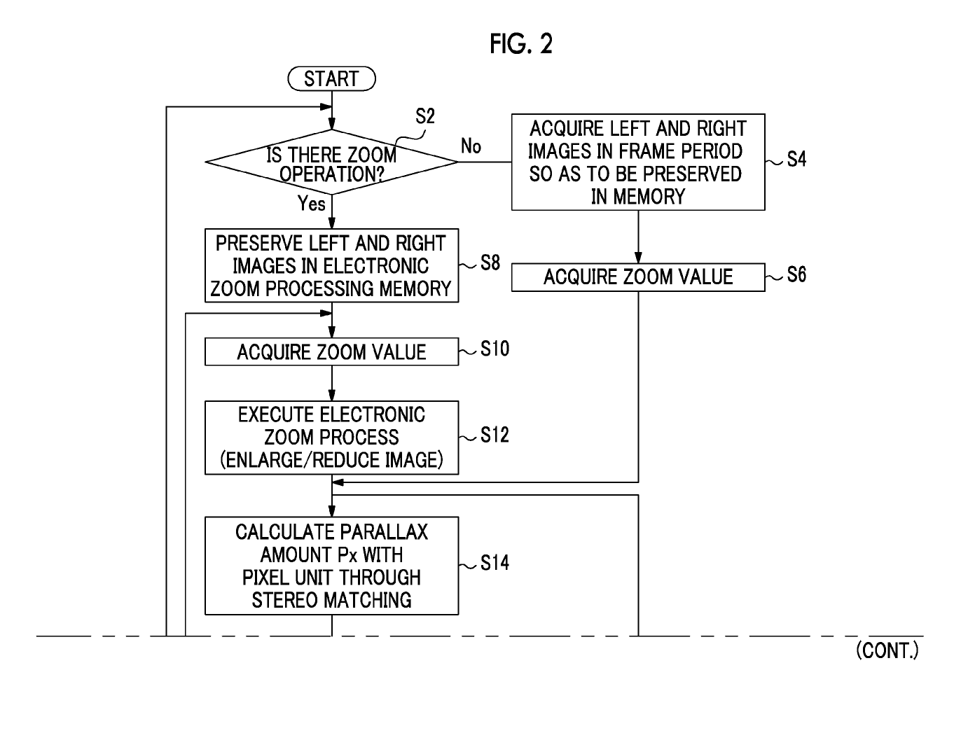

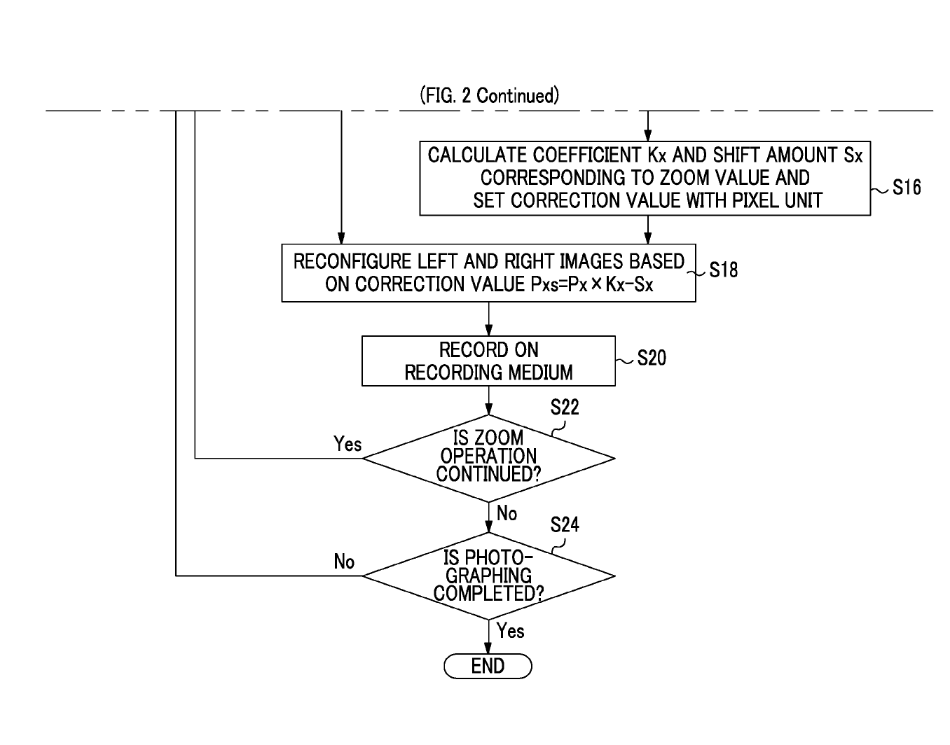

FIG. 2 is a flowchart illustrating an example of the flow of the image process performed in real time when moving images are captured. This process is executed according to a program by the control unit 25.

Whether or not a zoom operation is performed with the operation unit 16 is determined (step S2), and, if a zoom operation is not performed, the imaging unit 14 acquires stereoscopic images (a left eye image and a right eye image) in a frame period and preserves the acquired stereoscopic images in the image memory 15 (step S4), and acquires a zoom value from the operation unit 16 (step S6). The zoom value varies randomly from the wide angle end to the telescopic end. In the subsequent processes, the process is performed for each frame.

If the zoom operation is performed, stereoscopic images (a left eye image and a right eye image) corresponding to one frame when the zoom operation is performed (before the zoom value varies) are preserved in a memory for electronic zoom (step S8), the zoom value is acquired from the operation unit 16 (step S10), the stereoscopic images preserved in the image memory 15 are variably magnified (enlarged or reduced) by the electronic zoom processing unit 17 according to the acquired zoom value (step S12). The memory for electronic zoom may be embedded in the electronic zoom processing unit 17, and the image memory 15 which is divided into a memory for stereoscopic images in real time and a memory for electronic zoom may be used.

Next, the parallax amount calculation unit 18 calculates a parallax amount Px with the pixel units by performing corresponding point detection through stereo matching between the left eye image and the right eye image (step S14).

In addition, the parallax amount correction value calculation unit 19 calculates a correction value for correcting a parallax amount of each pixel of the stereoscopic images according to the parallax amount of each of the stereoscopic images calculated by the parallax amount calculation unit 18 and the zoom value acquired by the operation unit 16 (step S16).

Next, the parallax amount correction unit 20 reconfigures the left eye image and the right eye image based on the correction value (step S18). Here, the parallax amount of each pixel is corrected according to the parallax amount of each pixel calculated by the parallax amount calculation unit 18 and the zoom value acquired by the operation unit 16. Through this correction of the parallax amount, a variation amount of the parallax amounts of the stereoscopic images relative to a variation amount per unit of the zoom value is changed. That is to say, a correspondence relationship between a variation amount of the zoom value and a variation amount of the parallax amount is changed. Specifically, in a case where a parallax amount of a subject of the same subject distance decreases when the zoom value varies from the wide angle side to the telescopic side in the stereoscopic images before being corrected, the parallax amount is corrected such that a parallax amount of the subject of the same subject distance increases (or does not vary) when the zoom value varies from the wide angle side to the telescopic side in the stereoscopic images after being corrected.

Next, the recording medium interface 22 records the reconfigured stereoscopic images onto the recording medium 23. The monitor 21 and the external output device 24 may output the stereoscopic images.

Next, whether or not the zoom operation is continued is determined (step S22), and, if the zoom operation is continued, the process returns to step S10.

In addition, whether photographing is completed or photographing is continued is determined (step S24), and, if the photographing is continued, the process returns to step S2.

In the present process, while the acquired zoom value varies, the electronic zoom processing unit 17 variably magnifies the stereoscopic images (stereoscopic still images) of one frame immediately before or after the zoom value varies and outputs the variably magnified still images of one frame to the monitor 21, and, when the acquired zoom value does not vary, the electronic zoom processing unit 17 outputs stereoscopic images (stereoscopic moving images) of a plurality of frames to the monitor 21.

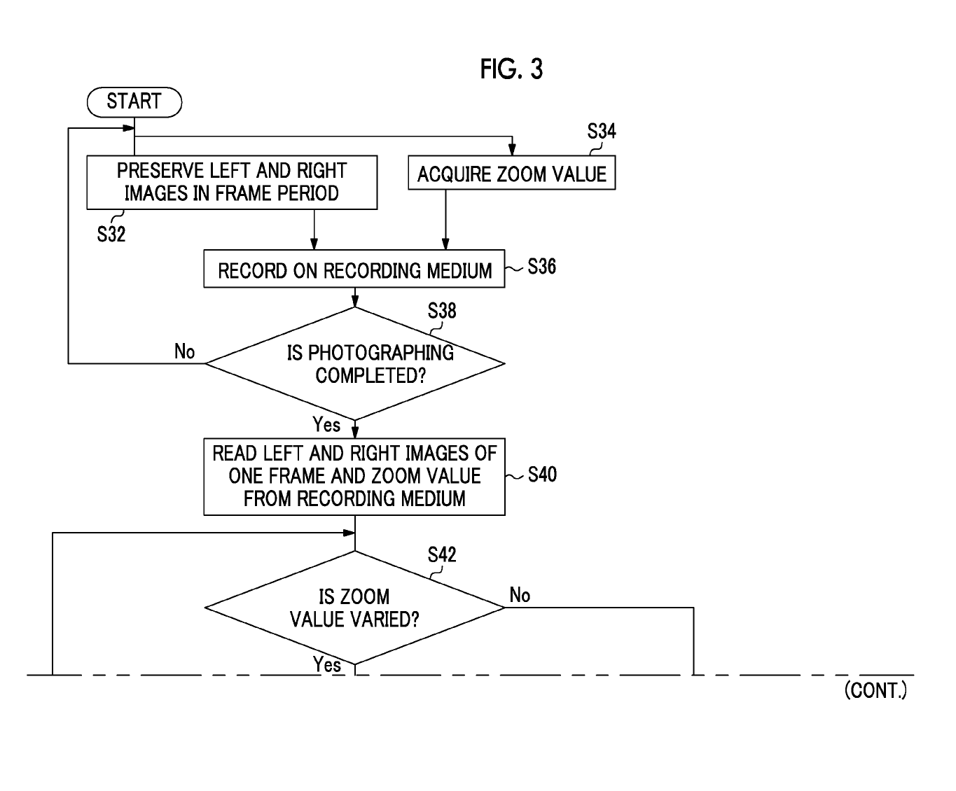

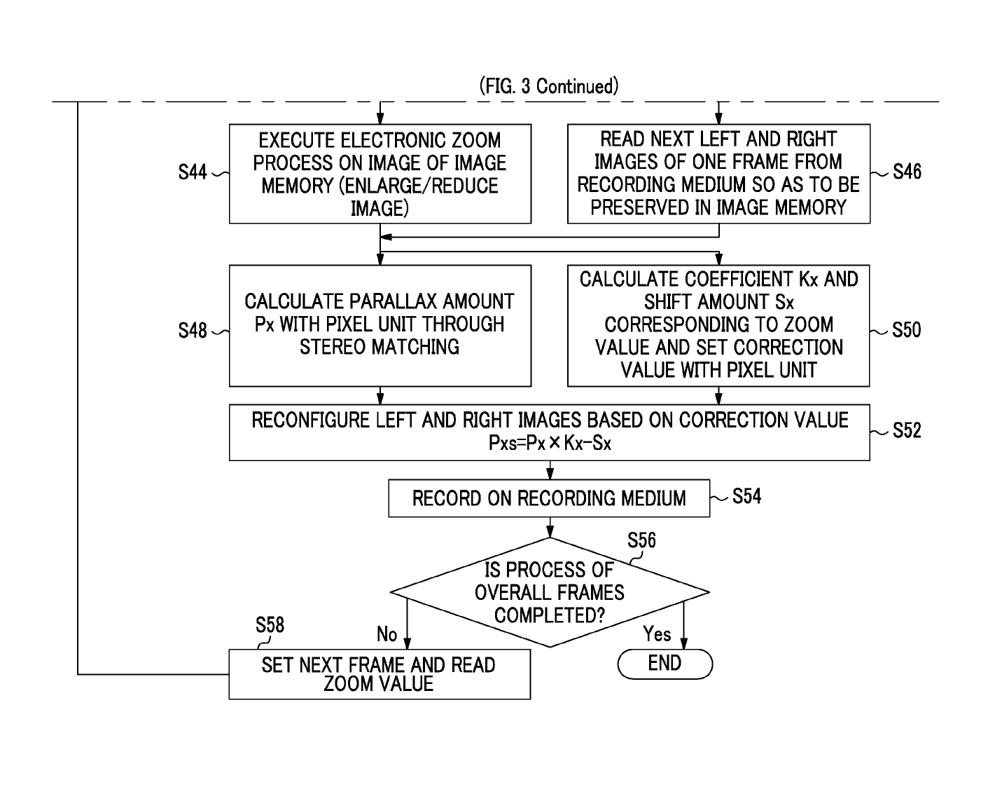

FIG. 3 is a flowchart illustrating an example of the flow of the image process performed after moving images are captured.

The processes in steps S32 and S34 are respectively the same as the processes in steps S4 and S6 of FIG. 2.

In step S36, the recording medium interface 22 records the stereoscopic images formed by a left eye image and a right eye image on the recording medium 23 for each frame. Here, the recording medium interface 22 appends zoom value information to the stereoscopic images for each frame and then records the stereoscopic images on the recording medium 23.

Whether photographing is completed or photographing is continued is determined in step S38, and, if photographing is continued, the process returns to steps S32 and S34.

After capturing of moving images is completed, the recording medium interface 22 reads the stereoscopic images (a left eye image and a right eye image) and the zoom value information for each frame from the recording medium in step S40.

In step S40, the recording medium interface 22 reads the stereoscopic images of one frame and the zoom value information from the recording medium 23.

In step S42, whether or not the zoom value varies is determined.

If the zoom value varies, in step S44, the electronic zoom processing unit 17 variably magnifies (enlarges or reduces) the stereoscopic images in the image memory 15.

If the zoom value does not vary, in step S46, the stereoscopic images (a left eye image and a right eye image) of the next frame are read from the recording medium 23 and are preserved in the image memory 15.

The processes in steps S48, S50, S52 and S54 are respectively the same as the processes in steps S14, S16, S18 and S20 of FIG. 2.

Whether or not all the frames are processed is determined in step S56, and, if all the frames are not processed, attention is paid to the next frame and a zoom value is read from the image memory 15 (step S58), and the process returns to step S40. If all the frames are processed, the present process finishes.

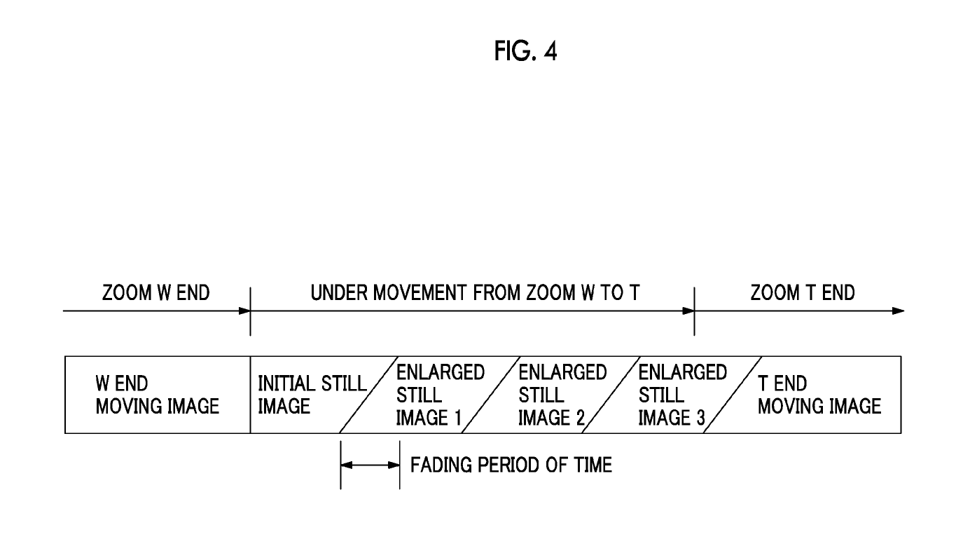

As illustrated in FIG. 4, the control unit 25 divides the period of time when a zoom value varies into a plurality of periods of time and changes a variation amount of the zoom value to not be a continuous variation but a stepwise variation, thereby performing control so as to sequentially display and record a plurality of still images which are variably magnified in a stepwise manner in the period of time when the zoom value varies.

In addition, the control unit 25 sets a total display duration of a plurality of variably magnified still images to be longer than a variation duration of the zoom value.

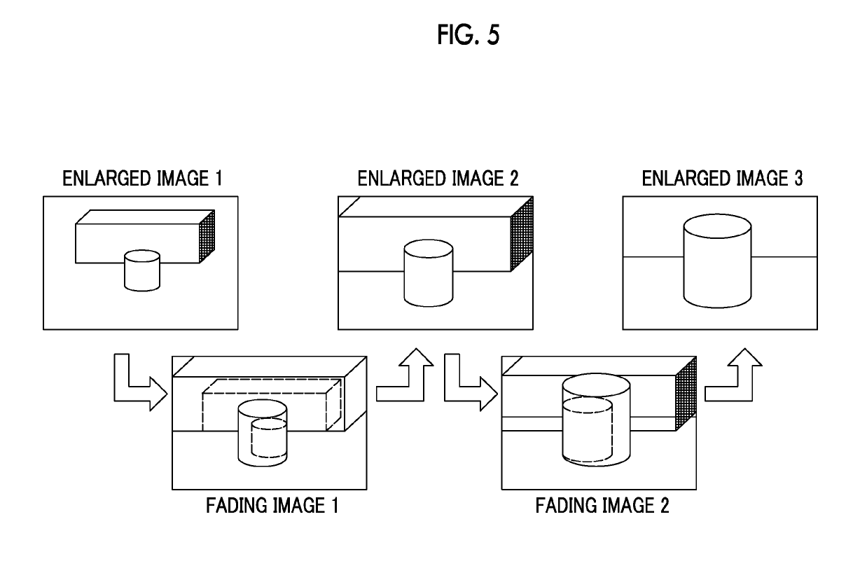

Further, as illustrated in FIG. 5, the control unit 25 changes display of a plurality of still images on the monitor 21 through fade-in and fade-out. In other words, the control unit 25 controls display such that one still image fades out and the other still image fades in.

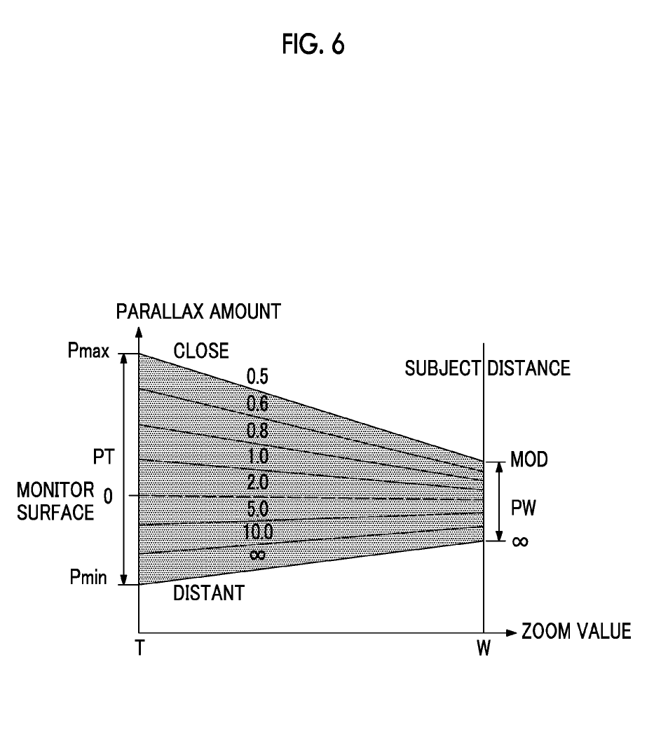

FIG. 6 illustrates a correspondence relationship (also referred to as a “parallax distribution”) between a zoom value and a parallax amount in a viewpoint image (a left eye image or a right eye image) before a parallax amount is corrected. The transverse axis expresses a zoom value, and the longitudinal axis expresses a parallax amount. In other words, a variation (parallax distribution) in the parallax amount relative to a variation in the zoom value is illustrated.

In FIG. 6, the center of the longitudinal axis is parallax(=0) of the convergence point, and a distance of the convergence point is set to 2.0 m in the present image capturing device. In the parallax distribution, the upper part of the center of the longitudinal axis indicates a parallax of a subject closer than the convergence point, and the lower part of the center of the longitudinal axis indicates a parallax of a subject more distant than the convergence point. The upper side of the parallax distribution indicates a parallax variation in a case where a subject distance is 0.5 m (MOD), and the lower side indicates a parallax variation in a case of an infinite distance.

In FIG. 6, a condition of the greatest parallax is at a zoom T end where the subject distance is 0.5 m, and a parallax amount under this condition is set to Pmax. Under this condition, a stereoscopic image is in a state of protruding from the monitor the most, and there is a high probability of an excessive parallax in which stereoscopic fusion is difficult. On the other hand, a condition of the smallest parallax is at a zoom W end where the distance is infinite, and a parallax amount under this condition is set to Pmin. Under this condition, a stereoscopic image is in a state of being recessed from the monitor the most, and there is a high probability that a shift amount of the stereoscopic image on the monitor may exceed (diverge from) the human interocular distance. Therefore, an upper limit and a lower limit of the parallax amount are required to be set through parallax correction.

In FIG. 6, a subject of which the subject distance is 2 m is a parallax of zero regardless of a variation in the zoom value, and there is no variation in the parallax amount. In a subject of which the subject distance is greater (distant) than 2 m, the parallax amount decreases when the zoom value varies from the W side to the T side. In other words, a subject image is observed in such an awkward manner that is being recessed from the monitor surface while the subject image increases, and thereby the observer's eyes performing stereoscopic vision increasingly feel fatigued.

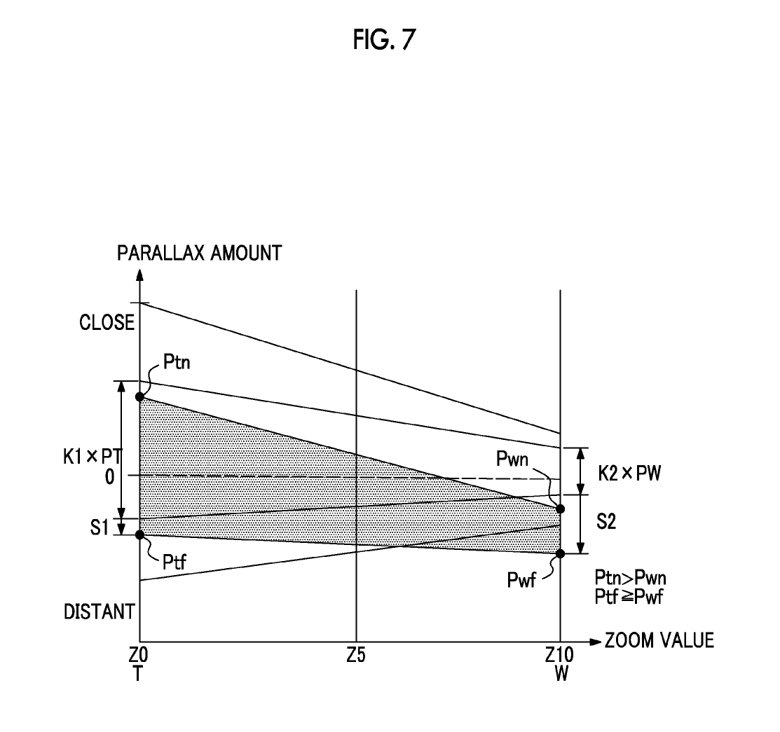

FIG. 7 illustrates a correspondence relationship (parallax distribution) between a zoom value and a parallax amount in a viewpoint image after a parallax is corrected by the parallax amount correction unit 20. The maximum parallax amount is corrected to Ptn from Pmax before being corrected, the minimum parallax amount is corrected to Pwf from Pmin, and thereby a parallax amount for each zoom value is corrected, so as to lie between Ptn and Pwf, by the parallax amount correction unit 20. In addition, there may be Ptf=Pwf.

In order to change (correct) the parallax distribution illustrated in FIG. 6 to the parallax distribution illustrated in FIG. 7, the parallax amount correction value calculation unit 19 calculates a coefficient k multiplied by a parallax amount and a shift amount S of a parallax amount. The parallax amount correction unit 20 multiplies a parallax amount of each pixel by the coefficient k and thereby compresses the parallax distribution width at each zoom value into a multiple of k. Specifically, in a case of the parallax amount maximum value Pmax>Ptn before correction is performed, k is set to 0<k<1 which gives Pmax≦Ptn after the correction is performed. In addition, in a case of the parallax amount maximum value Pmax≦Ptn before correction is performed, k may be set to k≧1

Next, the parallax amount correction unit 20 subtracts an amount of S1 from a parallax amount of each pixel so as to be shifted such that the maximum parallax amount Pmax becomes Ptn. These coefficient multiplication and shift are performed for each zoom value.

In addition, the parallax amount correction unit 20 increases a shift amount of the parallax amount by as much as the zoom value varies from the T end to the W end in order to achieve a natural zoom effect, which thus leads to Ptf≧Pwf and Ptn>Pwn. In other words, the minimum parallax amount is set to Pwf.

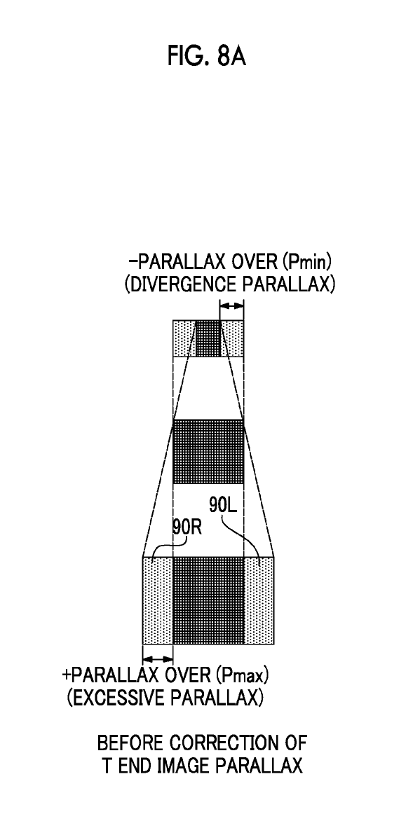

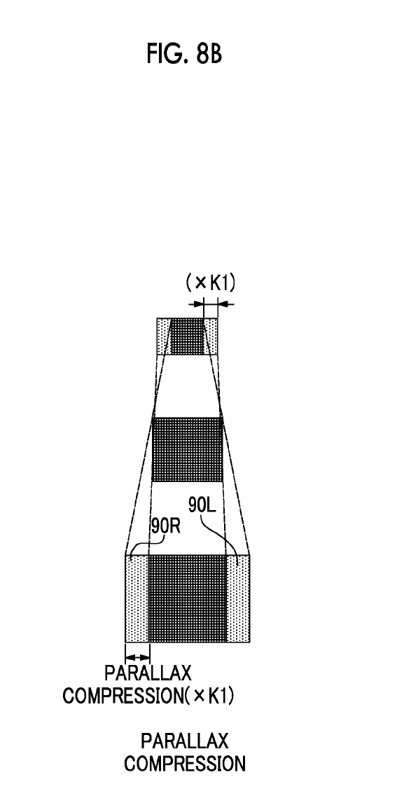

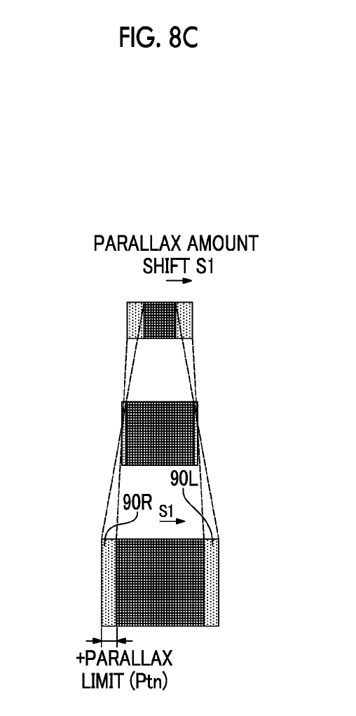

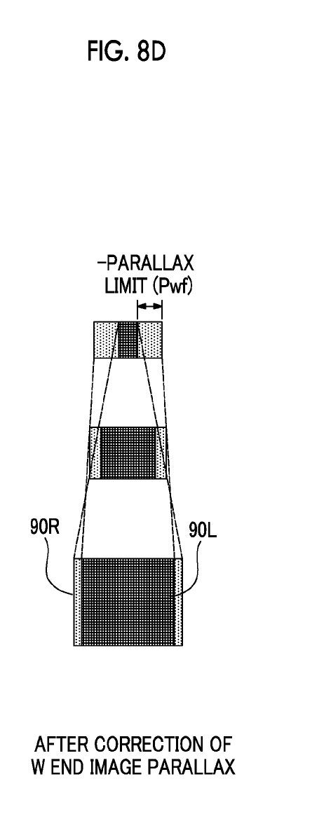

FIG. 8A illustrates a subject image 90L in the left eye image and a subject image 90R in the right eye image of the T end before a parallax amount is corrected, and FIG. 8B illustrates the subject image 90L in the left eye image and the subject image 90R in the right eye image of the T end after the parallax amount is compressed (coefficient multiplication). FIG. 8C illustrates the subject image 90L in the left eye image and the subject image 90R in the right eye image of the T end after the parallax amount is shifted. FIG. 8D illustrates the subject image 90L in the left eye image and the subject image 90R in the right eye image of the W end after the parallax is corrected. In addition, FIGS. 8A to 8D illustrate a rectangular subject image; however, in practice, a shape of the subject image is not limited.

Since an excessive parallax and a diverging parallax are caused in FIG. 8, parallax compression through multiplication of the coefficient k1 by the parallax amount as illustrated in FIG. 8B and the parallax amount shift S1 as illustrated in FIG. 8C are performed, and, as a result, a parallax amount of the stereoscopic images after being zoomed lies in a parallax limit.

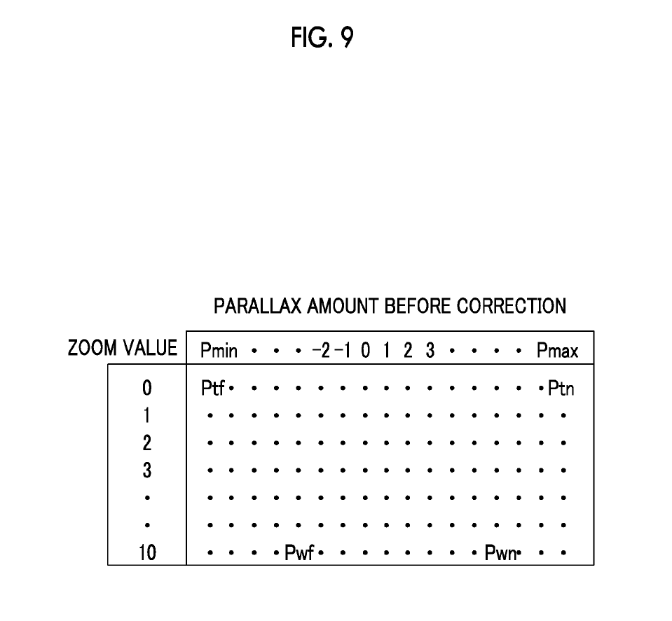

In addition, an order of the multiplication and subtraction to be processed may be any order. In addition, in a case where correction is set to be performed as in FIG. 7 in advance, a correspondence relationship between a zoom value and a parallax amount before and after being corrected is stored as table data in advance as illustrated in FIG. 9, and parallax correction is performed using the table data when a parallax is corrected, thereby reducing a processing time. In other words, the parallax amount correction value calculation unit 19 of FIG. 1 may be replaced with the table data of FIG. 8.

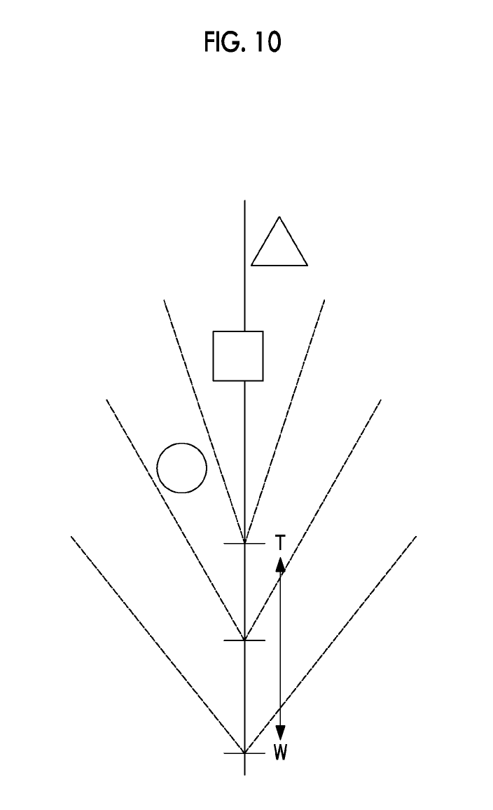

FIG. 10 is a schematic diagram illustrating stereoscopic images in a case where the stereoscopic images of which a parallax is corrected are displayed on the monitor 21.

When a zoom value varies from the wide angle W side to the telescopic T side, a parallax amount varies such that a viewpoint position becomes close to a subject (or the subject becomes close to the viewpoint position), and thus awkwardness due to zooming is improved.

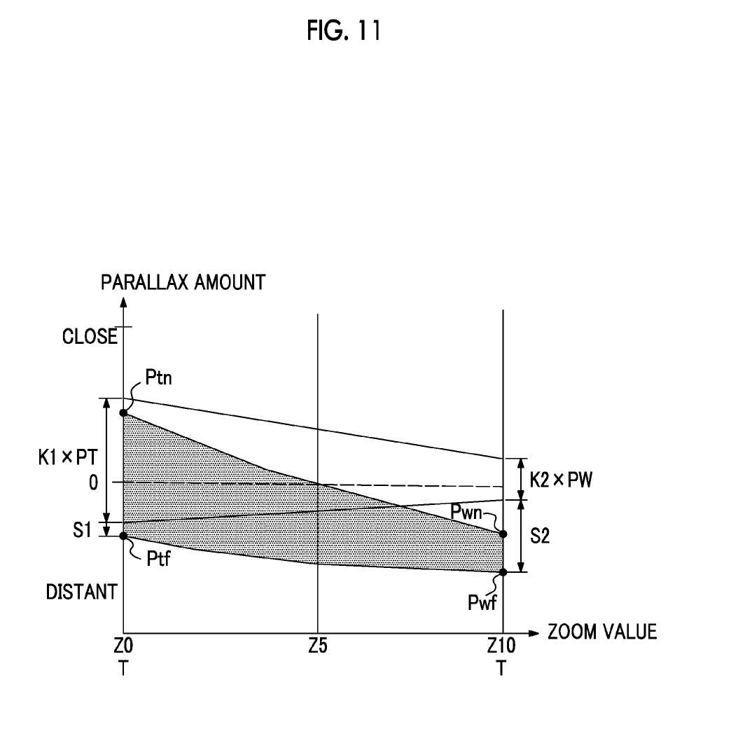

FIG. 11 illustrates a case where a line between Ptf and Pwf and a line between Ptn and Pwn are nonlinear lines, and, the closer to the T (telescopic) end, the larger the variation amount of a parallax amount relative to the variation amount of a zoom value. In other words, the closer to the T end, the larger the movement amount of the subject in the depth direction. Thereby, a movement state of the subject is more realistic.

A correction value used for parallax amount correction may be set based on a user set value. For example, an input or a selection of the size (display screen size) of the monitor 21 (a stereoscopic vision display device) which outputs stereoscopic images is received by the operation unit 16. This is because a limit value of parallax divergence is defined by the display screen size.

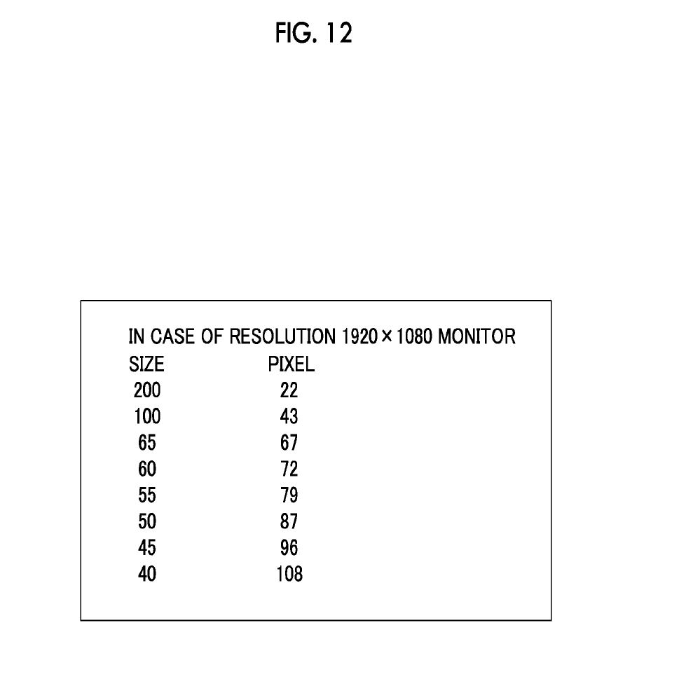

FIG. 12 illustrates a correspondence relationship between a display size and pixels in a monitor with the resolution 1920×1080 dots.

In addition, the operation unit 16 may be provided with a portion which receives an input or a selection of an interocular distance for each user. If a child is targeted as an observer of stereoscopic images, the interocular distance is 5 cm, and the number of pixels of the monitor size corresponding to 5 cm is set as the parallax amount lower limit value Pwf.

The parallax amount upper limit value Ptn is set to about 57 pixels, for example, on the premise that viewing is performed at a distance which is three times the height of the monitor screen. Since Ptn is defined from an allowable range of stereoscopic fusion, there is an individual difference. Therefore, Ptn is preferably changed by a user's setting.

According to the present embodiment, discomfort of an observer during zoom variation can be improved, and thus fatigue from stereoscopic vision can be suppressed. An excessive parallax and a divergence state are preferably improved by correcting a parallax amount with respect to variation in a zoom value from the wide angle end to the telescopic end.

### Second Embodiment

Next, the second embodiment will be described. In the second embodiment, a zooming effect is emphasized, and parallax excess or parallax divergence is also prevented, by increasing a variation amount of a parallax amount relative to a variation amount of a zoom value.

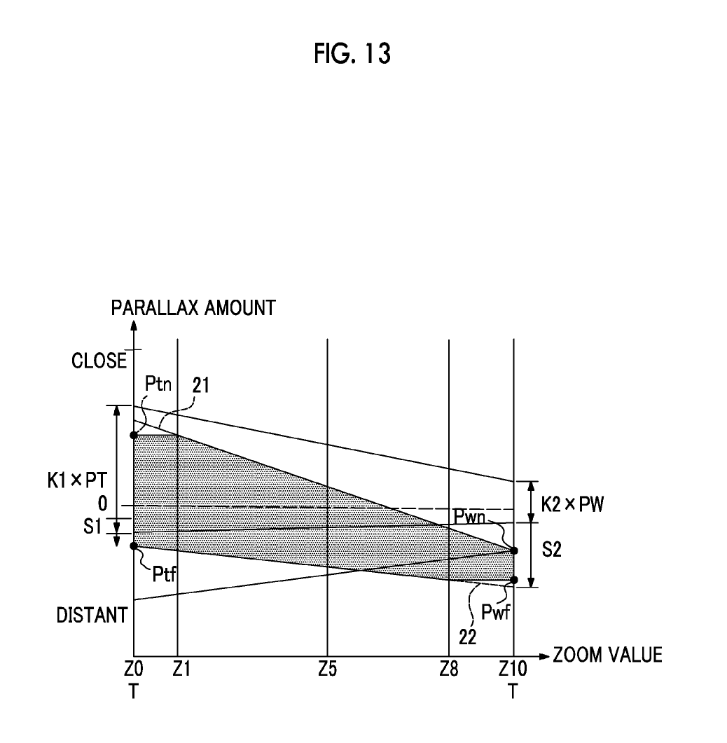

FIG. 13 illustrates a correspondence relationship (parallax distribution) between a zoom value and a parallax amount in a viewpoint image after a parallax is corrected by the parallax amount correction unit 20 according to the second embodiment.

In order to emphasize zooming, preferably, a variation amount of the parallax amount relative to a variation amount of the zoom value is increased by further increasing the slope of each of the line between Ptf and Pwf and the line between Ptn and Pwn. In other words, a movement amount of a subject in the depth direction relative to a variation of a zoom value in stereoscopic images increases, and thereby a zooming effect can be emphasized.

In that case, as indicated by the dotted lines 21 and 22 in FIG. 13, there is a high probability that a parallax amount after being corrected may be larger than the parallax amount upper limit value Ptn or may be smaller than the parallax amount lower limit value Pwf in the telescopic (T) side or the wide angle (W) side.

Therefore, the parallax amount correction unit 20 corrects the correction amount such that a parallax amount after being corrected lies in a range from the parallax amount upper limit value Ptn to the parallax amount lower limit value Pwf. For example, in a case where a zoom value acquired by the operation unit 16 is smaller than Z1, and a parallax amount before being corrected is larger than the parallax amount upper limit value Ptn, a parallax amount after being corrected is fixed to Ptn. In addition, for example, in a case where a zoom value acquired by the operation unit 16 is larger than a specific zoom value Z8, and a parallax amount before being corrected is smaller than Pwf, a parallax amount after being corrected is fixed to Pwf.

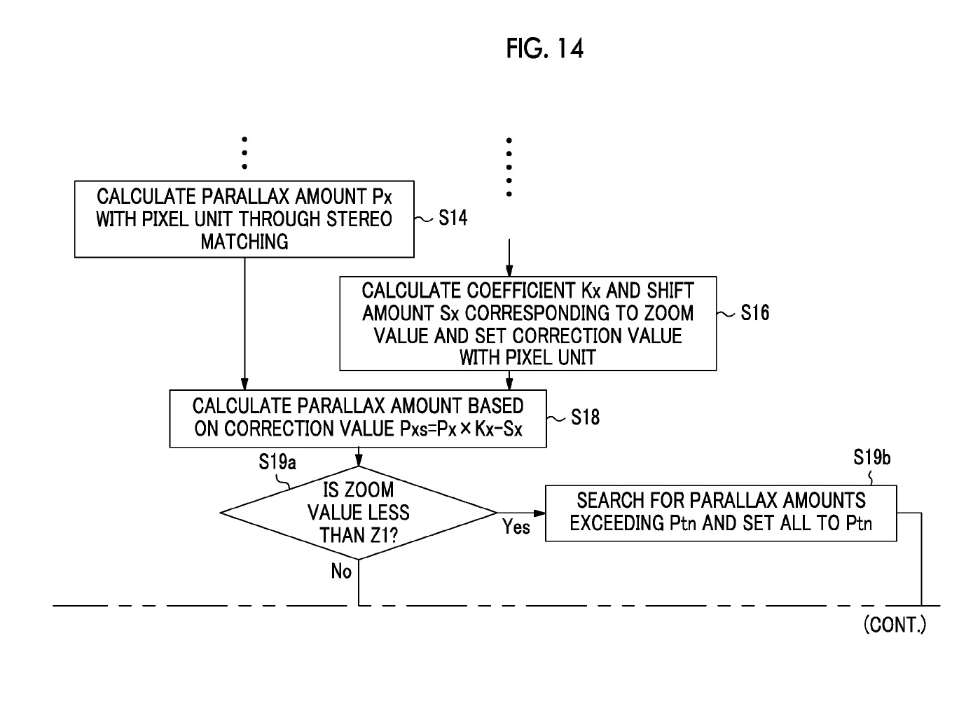

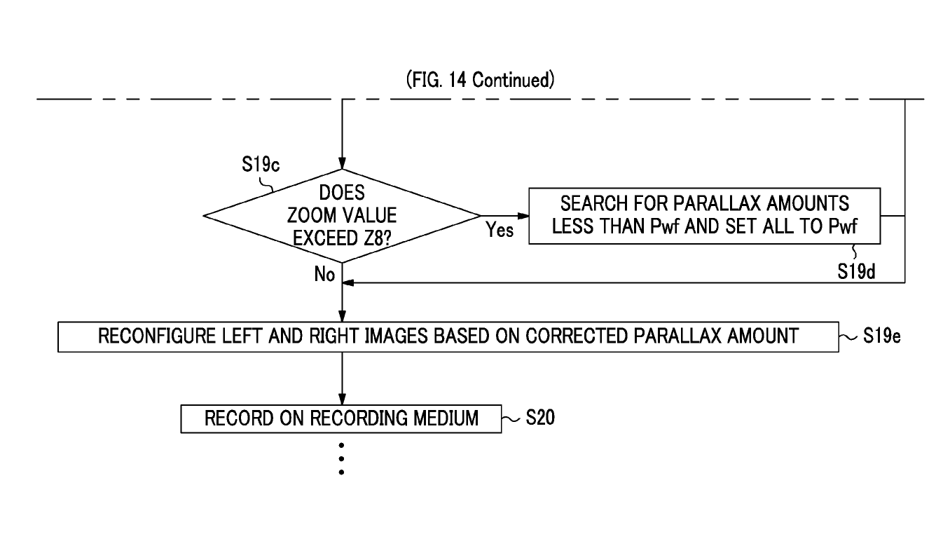

FIG. 14 is a flowchart illustrating a main part of the flow of the image process according to the present embodiment.

In addition, as illustrated in FIG. 2, the processes in steps S2 to S18 are performed in the same manner as in the first embodiment. In step S18, the parallax amount correction unit 20 calculates (primary correction) a parallax amount based on a correction value, which is the same process as in step S18 of FIG. 2.

In step S19a, whether or not the zoom value is smaller than Z1 is determined, and, if smaller than Z1, in step S19b, pixels with a parallax amount larger than the parallax amount upper limit value Ptn are all detected, and the parallax amounts of the pixels are all set to Ptn. In addition, in step S19c, whether or not a zoom value is greater than Z8, and, if larger than Z8, in step S19d, pixels with a parallax amount smaller than the parallax amount lower limit value Pwf are detected, and the parallax amounts of the pixels are all set to Pwf. In other words, in steps S19a to S19d, of the parallax amounts in a parallax map immediately after the correction in step S18, parallax amounts deviated from the range of Ptn to Pwf are set to Ptn or Pwf.

In step S19e, the parallax amount correction unit 20 reconfigures (secondary correction) a left eye image and a right eye image based on a secondary correction value.

The subsequent processes from step S20 are the same as the processes from step S20 illustrated in FIG. 2.

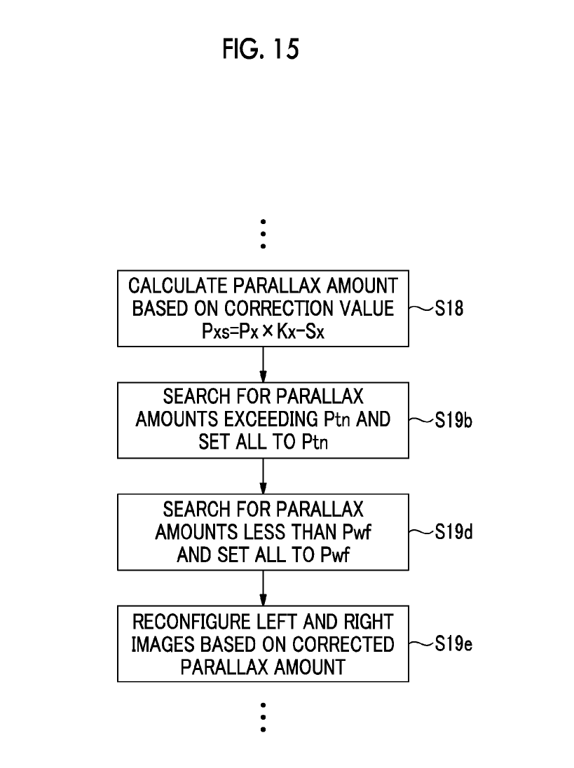

These processes may be performed in the overall zoom ranges regardless of a zoom value as illustrated in a flowchart of FIG. 15. In other words, the processes in steps S19b, S19d and S19e illustrated in FIG. 14 are performed in this order after step S18.

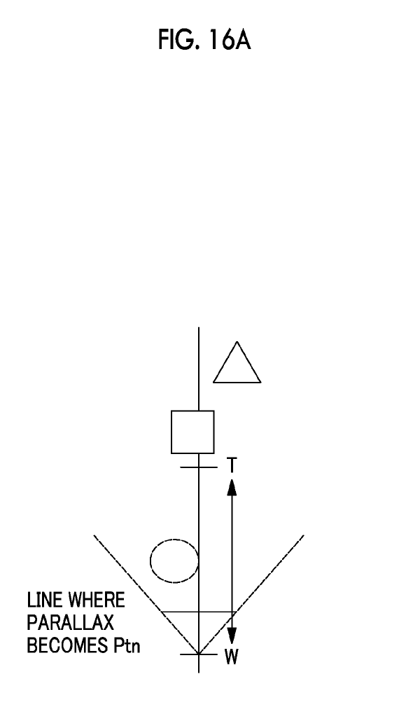

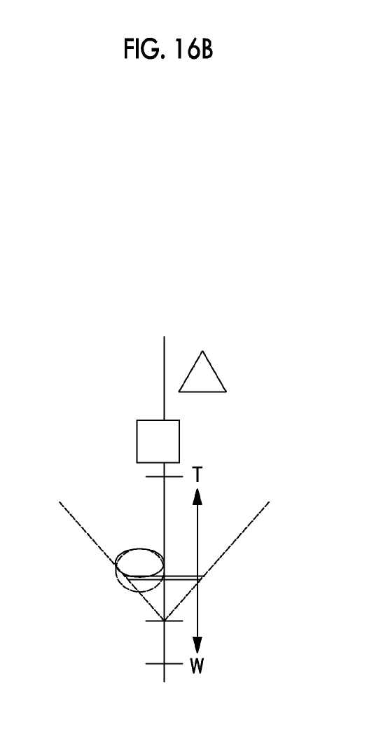

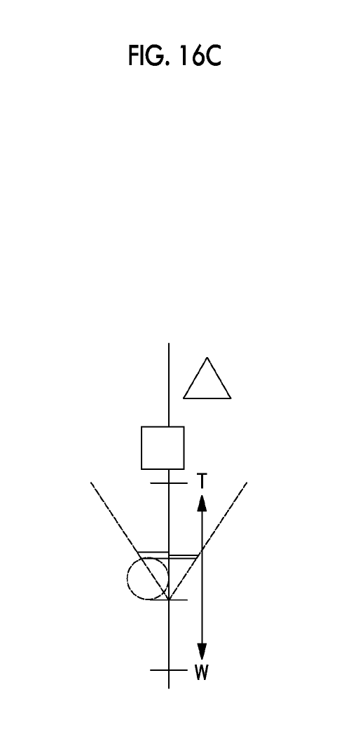

FIGS. 16A to 16C schematically illustrate a state of a stereoscopic image of a subject in a case where a parallax amount exceeds Ptn when a zoom value varies in the telescopic direction. FIG. 16C illustrates that, if the parallax amount exceeds Ptn, the subject image is viewed in a planar shape. In addition, in FIG. 16B, as the zoom value increases, the subject image gradually becomes a planar shape (that is, a distance difference between the front end and the rear end of the subject image is gradually compressed).

In the graph indicating a correspondence relationship between a zoom value and a parallax amount as illustrated in FIG. 13, the slope of the line of the same subject distance such as the line between Ptn and Pwn and the line between Ptf and Pwf may be varied by receiving a user's setting input operation as an emphasizing level of a zoom sense.

In this case, the larger the emphasizing level is, the greater the slope of the line (such as the line between Ptn and Pwn of the same subject distance is set to be, the line between Ptf and Pwf, or the like), according to an emphasizing level set by the user. The greater the slope, the greater the value of Ptf with the sign, and the smaller the value of Pwn with the sign. In addition, Ptf≧Pwf and Ptn>Pwn.

According to the present embodiment, a zooming effect can be emphasized, and parallax excess or parallax divergence can also be prevented.

### Third Embodiment

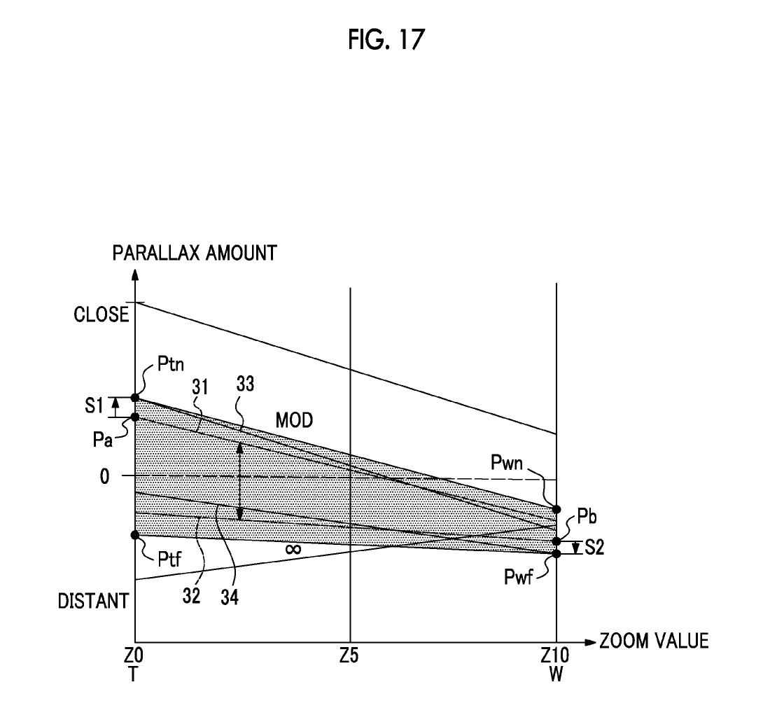

There are cases where a subject distance range is narrow in practical photographing. For example, in photographing indoors, there is no infinite subject, and, in photographing outdoors, even a point-blank range is a more distant range than MOD (shortest focusing distance). In that case, a distance of parallax amounts after being corrected lies, for example, in a range between the dotted line 31 and the dotted line 32 of FIG. 17. In this case, since there is a margin to the limit values (Ptn and Pwf) from the maximum value Pa and the minimum value Pb in a practical parallax distribution, the margin can be assigned for emphasis of a zooming effect.

Specifically, shift amounts 51 and S2 of parallax correction may be adjusted such that the maximum value Pa becomes the upper limit value Ptn, and the minimum value Pb becomes the lower limit value Pwf. As a result, after parallax correction is performed, the parallax distribution is changed from the range between the dotted line 31 and the dotted line 32 to the range between the solid line 33 and the solid line 34, and thus there is an increase in the slope of the line indicating a correspondence relationship between a zoom value and a parallax amount at the same subject distance.

In the present embodiment, the operation unit 16 receives an input of setting information for setting a parallax correction value used to correct a parallax amount. The parallax amount correction value calculation unit 19 calculates a parallax amount correction value based on the input setting information.

The setting information is, for example, a display size of the monitor 21 (monitor size).

The setting information may be, for example, at least one of subject distance information of the closest subject and subject distance information of the most distant subject.

In addition, a zoom value may be set to the telescopic end or wide angle end under the control of the control unit 25, and a parallax amount correction value may be calculated by the parallax amount correction value calculation unit 19 based on a parallax amount of a focused pixel.

In addition, the operation unit 16 may receive an input of zoom effect setting information for setting a variation amount of a parallax amount relative to a variation amount of a zoom value, and the parallax amount correction value calculation unit 19 may calculate a parallax amount correction value based on the input zoom effect setting information.

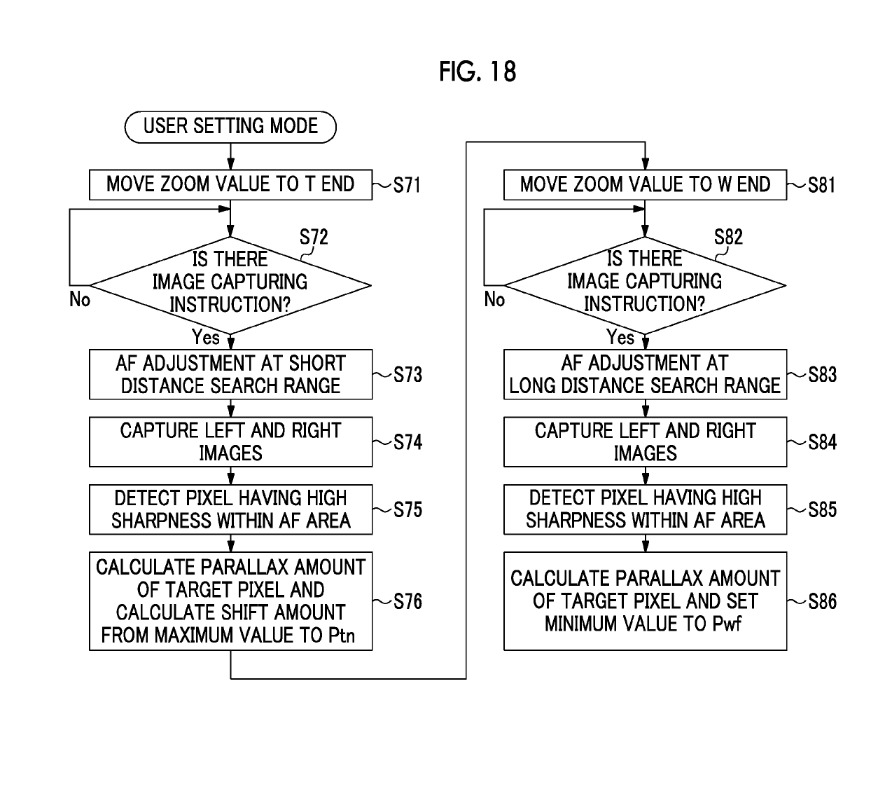

FIG. 18 is a flowchart illustrating an example of the flow of the user setting process.

In FIG. 18, when a user setting mode arrives, first, a zoom value (zoom position) of the imaging lenses 11L and 11R is moved (set) to the T end (step S71), a user is guided from the monitor 21 such that a subject with the shortest subject distance from the user lies in the AF area among subjects which are photographing targets, and an image capturing instruction operation is received by the operation unit 16 (step S72). When the image capturing instruction is received, a focus position is found from the shortest distance by giving priority to the short distance range (step S73). In other words, the closest subject is focused among the subjects which are photographing targets. Next, a left eye image and a right eye image are captured (step S74), pixels with the sharpness higher than a preset threshold value are detected in the AF area (step S75), parallax amounts of the pixels are calculated, the parallax amount maximum value Pa is set, and a shift amount (Ptn−Pa) from the parallax amount maximum value Pa to Ptn is calculated (step S76).

Next, the zoom value (zoom position) of the imaging lenses 11L and 11R is moved (set) to the W end (step S81), the user is guided from the monitor 21 such that a subject with the longest subject distance from the user lies in the AF area among subjects which are photographing targets, and an image capturing instruction operation is received by the operation unit 16 (step 82). When the image capturing instruction is received, a focus position is found from the longest distance by giving priority to the long distance range (step S83). In other words, the most distant subject is focused among the subjects which are photographing targets. Next, a left eye image and a right eye image are captured (step S84), pixels with the sharpness higher than a preset threshold value are detected in the AF area (step S85), parallax amounts of the pixels are calculated, the parallax amount minimum value Pb is set, and a shift amount (Pb−Pwf) from the parallax amount minimum value Pb to Pwf is calculated (step S86).

In addition, since stereo matching is performed when a parallax amount is obtained, matching accuracy of an image with high sharpness is improved, and thus accuracy of a parallax amount is improved.

Although, in the setting method, a shift amount of a parallax amount is calculated in both the wide angle end and the telescopic end, the present invention is not limited to this case, and a shift amount of a parallax amount is calculated in either the wide angle end or the telescopic end.

In addition, the operation unit 16 may receive a direct input operation (or a selective input operation) of subject distance information of the closest subject (the minimum subject distance) and subject distance information of the most distant subject (the maximum subject distance) with respect to a user.

The operation unit 16 may receive an input of zoom effect setting information for setting a variation amount of a parallax amount relative to a variation amount of a zoom value, and the parallax amount correction value calculation unit 19 may calculate parallax amount correction value based on the input zoom effect setting information.

As above, although a case where still images are displayed during zooming has been described as an example, the present invention is not particularly limited to such a case. The present invention may be applied to a case where moving images are displayed during zooming.

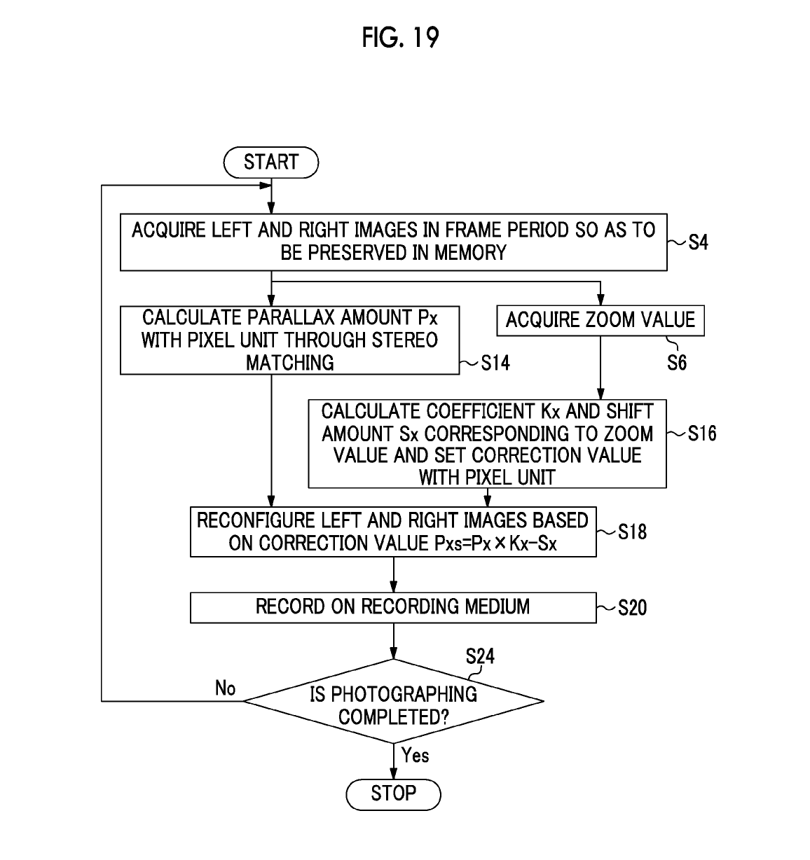

FIG. 19 is a flowchart illustrating an example of the flow of the image process performed in real time when moving images are captured. The present process is executed according to a program by the control unit 25. In addition, the same steps as the steps illustrated in FIG. 2 are given the same reference numerals, and, only differences will be described here.

In this example, when the operation unit 16 receives an instruction operation for varying a zoom value, the control unit 25 drives the zoom lenses of the imaging lenses 11L and 11R using a lens driving unit (not shown). In FIG. 19, the control thereof is not illustrated.

The processes in steps S4, S6, S14, S16, S18 and S20 of FIG. 19 are the same as the processes in the steps of the same reference numerals of FIG. 2. To summarize, the parallax amount calculation unit 18 calculates a parallax amount of each pixel between a plurality of viewpoint images (step S14), and the parallax amount correction unit 20 corrects a parallax amount of each pixel of stereoscopic images according to the parallax amount of each pixel and a zoom value (step S18).

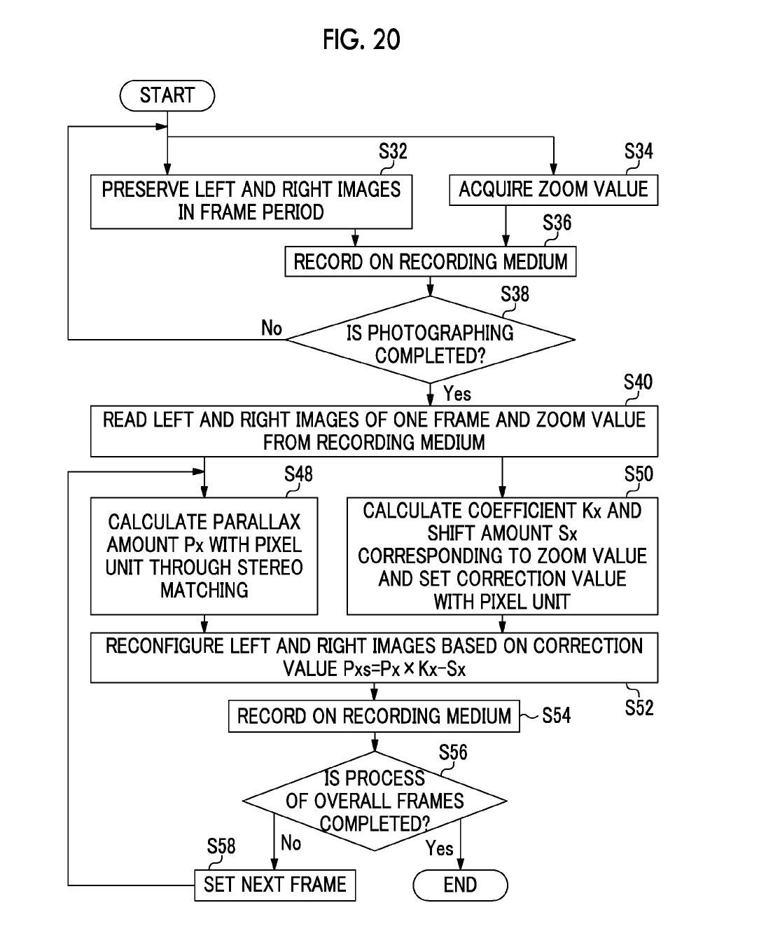

FIG. 20 is a flowchart illustrating an example of the flow of the image process performed after moving images are captured. This process is executed by the control unit 25 according to a program. In addition, the same steps as the steps illustrated in FIG. 3 are given the same reference numerals, and, only differences will be described here.

The processes in steps S32 to S40 and S48 to S58 of FIG. 20 are the same as the processes in the steps of the same reference numerals of FIG. 3. To summarize, the parallax amount calculation unit 18 calculates a parallax amount of each pixel between a plurality of viewpoint images (step S48), and the parallax amount correction unit 20 corrects a parallax amount of each pixel of stereoscopic images according to the parallax amount of each pixel and a zoom value (step S52).

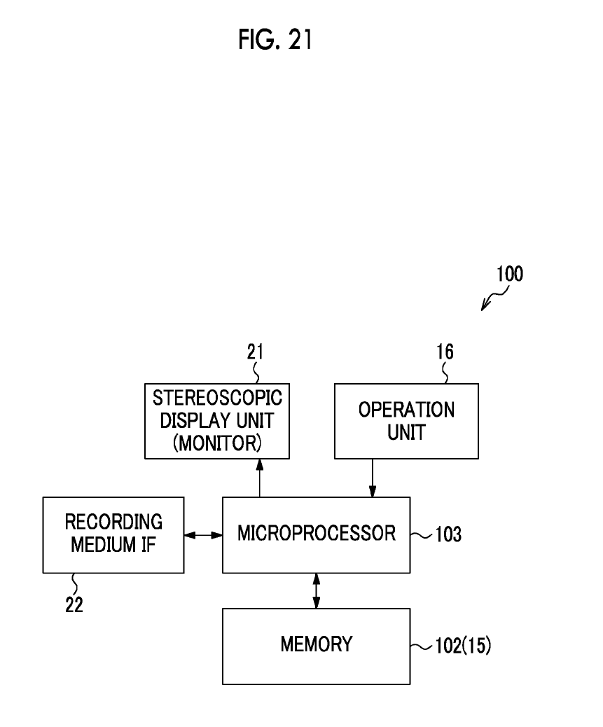

In addition, although a case where the present invention is applied to the image capturing device has been described as an example, the present invention is not particularly limited to such a case. For example, the present invention may be applied to a computer apparatus 100 illustrated in FIG. 21. In FIG. 21, the constituent elements illustrated in FIG. 1 are given the same reference numerals.

The personal computer apparatus 100 illustrated in FIG. 21 includes an operation unit 16, a stereoscopic display unit 21 (monitor), a recording medium interface 22, a memory 102, and a microprocessor 103. The microprocessor 103 has functions of the electronic zoom processing unit 17, the parallax amount calculation unit 18, the parallax amount correction value calculation unit 19, the parallax amount correction unit 20, and the control unit 25 of FIG. 1. The memory 102 has a function of the image memory 15 of FIG. 1.

The present invention is not limited to the examples described in the present specification or the examples illustrated in the drawings and may include various design modifications or alterations in the scope without departing from the spirit of the present invention.

What is claimed is:

1. An image processing device comprising:
an image acquisition unit that acquires stereoscopic images formed by a plurality of viewpoint images;
a zoom value acquisition unit that acquires a zoom value;
a parallax amount calculation unit that calculates a parallax amount of each pixel between the plurality of viewpoint images; and
a parallax amount correction unit that corrects variation amounts of the parallax amounts of at least some pixels of the stereoscopic images acquired by the image acquisition unit relative to a variation amount per unit of the zoom value, according to the parallax amount of each pixel calculated by the parallax amount calculation unit and the zoom value acquired by the zoom value acquisition unit, in relation to the plurality of viewpoint images.

2. The image processing device according to claim 1, wherein the parallax amount correction unit corrects the parallax amount so as for a parallax amount of a subject of the same subject distance to increase or be constant when the zoom value varies from a wide angle side to a telescopic side in the stereoscopic still images after being corrected in a case where the parallax amount of the subject of the same subject distance decreases when the zoom value varies from the wide angle side to the telescopic side in the stereoscopic images before being corrected.

3. The image processing device according to claim 1, wherein the parallax amount correction unit corrects the parallax amount by multiplying the parallax amount before being corrected by a coefficient and shifting the parallax amount after being multiplied.

4. The image processing device according to claim 1, wherein the parallax amount correction unit corrects the parallax amount so as for a shift amount of the parallax amount to increase from a telescopic end to a wide angle end.

5. The image processing device according to claim 1, wherein the parallax amount correction unit corrects the parallax amount so as for a parallax amount of a subject of the same subject distance to nonlinearly increase when the zoom value varies from a wide angle end to a telescopic end.

6. The image processing device according to claim 1, wherein the parallax amount correction unit corrects the parallax amount so as to lie in a range of a specific upper limit value to a specific lower limit value.

7. The image processing device according to claim 1, further comprising:
a setting information input unit that receives an input of setting information for setting a parallax amount correction value used to correct the parallax amount; and
a parallax amount correction value calculation unit that calculates the parallax amount correction value based on the setting information input by the setting information input unit.

8. The image processing device according to claim 7, wherein the setting information is a display size of the stereoscopic images.

9. The image processing device according to claim 1, further comprising:
a parallax amount correction value calculation unit that sets the zoom value to a telescopic end or a wide angle end, and calculates a correction value of the parallax amount based on a parallax amount of a focused pixel.

10. The image processing device according to claim 7, wherein the setting information includes at least one of subject distance information of the closest subject and subject distance information of the most distant subject.

11. The image processing device according to claim 1, further comprising:
a zoom effect setting information input unit that receives an input of zoom effect setting information for setting a variation amount of the parallax amount relative to a variation amount per unit of the zoom value; and
a parallax amount correction value calculation unit that calculates a parallax amount correction value based on the zoom effect setting information input by the zoom effect setting information input unit.

12. The image processing device according to claim 1, further comprising:
an electronic zoom processing unit that performs electronic zoom through image processing,
wherein the zoom value acquisition unit acquires a zoom value of the electronic zoom.

13. An image capturing device comprising:
the image processing device according to claim 1,
wherein the image acquisition unit includes
an imaging lens having a zoom lens; and
an imaging device capturing a subject image formed by the imaging lens, and
wherein the zoom value acquisition unit acquires a zoom value of the zoom lens.

14. An image processing method in the image processing device according to claim 1, using an image acquisition unit which acquires stereoscopic images formed by a plurality of viewpoint images, a zoom value acquisition unit which acquires a zoom value, and an output unit which outputs the stereoscopic image, the method comprising:
calculating a parallax amount of each pixel between the plurality of viewpoint images; and
correcting variation amounts of the parallax amounts of at least some pixels of the stereoscopic images acquired by the image acquisition unit relative to a variation amount per unit of the zoom value, according to the parallax amount of each pixel calculated in the calculating of the parallax amount and the zoom value acquired by the zoom value acquisition unit, in relation to the plurality of viewpoint images.
